(19) United States
(12) Patent Application Publication
(10) Pub. No.: US 2005/0038930 A1
(43) Pub. Date: Feb. 17, 2005

(54) Bus station

(76) Inventors: Klaus-Dieter Meier, Leonberg (DE); Ewald Mauritz, Weissach (DE); Heiko Buehring, Oldenburg (DE); Hans Bogenreider, Manching (DE); Holger Wulff, Ingolstadt (DE)

Correspondence Address: KENYON & KENYON, ONE BROADWAY, NEW YORK, NY, 10004, US

(21) Appl. No.: 10/491,735

(22) PCT Filed: Sep. 12, 2002
(86) PCT No.: PCT/DE02/03391

(30) Foreign Application Priority Data
Oct. 4, 2001 (DE) 101488653

(51) Int. Cl. G06F 3/00

(52) U.S. Cl. 710/15

(57) ABSTRACT

A bus station addressable using at least one group address is provided. For the evaluation of the group addresses, the bus station has a decoder for converting a group address received via the bus into a decimal group address, a register in which the permissible group addresses are stored as a register word, and a logic circuit for the comparison of the decoding word and the register word. The logic circuit generates an enabling signal for the bus station, as a function of the comparison.

### FIELD OF THE INVENTION

The present relates to bus systems, in particular bus system used to communicate data from sensor devices in motor vehicles.

### BACKGROUND INFORMATION

German Published Patent Application No. 197 40 306 describes a bus system in which several units that are connected to the bus system may be combined into groups which can then be addressed jointly. This is described in the above document in the context of a master-slave system.

### SUMMARY OF THE INVENTION

The bus station according to the present invention has the advantage that a greater flexibility is possible without an additional employment of address register sets and associated logic circuits. A smaller chip surface is then possible for a bus station IC, as well as simpler programming of the bus stations. By converting the received group address into a decimal number, it is possible to define a plurality of group addresses, on account of the properties of the decimal numbers. For example, uneven or even group addresses may be used as a subset, in each case, of group addresses for which the respective sensor is addressed. Individual decimal numbers, which are considered to be a group address for the respective bus station, can also be defined by the register word.

According to an embodiment of the present invention, the bus station is connectable both to a serial bus and a parallel bus. In this context, both a master-slave system and a multi-master system may be used. Multi-master systems are known, for example, from automobile technology, as CAN (controller area network) buses, while master-slave systems are used in sensor and in ignition buses.

According to an embodiment, a logic circuit may be set up using AND circuits and an OR circuit, the AND circuits comparing the respective bits of a register word that is stored in a register and a decoding word that is present at the output of a decoder. The output signals of the AND operations are then compared to one another using an OR operation. If an AND operation emits a 1 as output signal, then, because of the OR operation, an enabling signal results for the bus station. Alternatively, it is also possible to implement this function in software.

The bus station may be designed either as a sensor, such as in a sensor bus, or as a means of restraint, such as in a firing bus. Besides these, there are, however, many other possible applications in motor vehicle technology, in manufacturing technology, household technology and communications technology.

In addition, the bus station may be designed as a slave, so that, for example, in a scanning mode, i.e., a polling operation, a bus master addresses the individual bus stations using group addresses, and then the slave stations according to the present invention can recognize their group addresses. This makes a master-slave system particularly flexible in view of the addressing of the individual slaves.

### BRIEF DESCRIPTION OF THE DRAWINGS

FIG. 1 shows an exemplary parallel bus system.

FIG. 2 shows an exemplary serial bus system.

FIG. 3 shows an exemplary comparison of a decoding word and a register word.

FIG. 4 shows an exemplary circuit diagram of a bus station according to an embodiment of the present invention.

### DETAILED DESCRIPTION

Bus systems are being used in greater numbers of technical fields because of lower requirements for connection lines. One important application is where several bus stations are simultaneously addressed using a single address. These addresses are called group addresses. Different bus stations have partially different tasks, and therefore have to be addressed with different frequencies, so that great flexibility in group addressing is required in this case. In particular, in the case of a bus for restraint systems such flexible group addressing is necessary, since, in this case, sensors having different rates of repetition and data capacity are connected to the bus. In this case, so-called polling is applied, in that the individual sensors are prompted to provide data, such as sensor signals. Since individual sensors are addressed with different frequencies, flexible group addressing is of use, in this instance. In this context, the sensors are designed as bus stations.

According to the present invention, the individual bus stations are configured such that the group address is converted into a decimal group address, in order to be able to use the flexibility of decimal numbers. In this context it is now possible, for example, to use only even or odd numbers for group addressing. In this conversion, one bit in the decoding word represents the corresponding decimal number. If, for example, the maximum decimal number of the group addresses is sixteen, then sixteen bits are used to indicate the different decimal numbers one through sixteen by setting the respective bit. This also makes clear that in a subsequent logic circuit, only one AND operation can lead to a logical 1 at the output, where the AND circuits in the logic circuit making a bit-wise comparison of the decoding word and the register word. At this AND operation, the register word, that is permanently stored in the bus station, also has to have a 1. Thus, there is also a register word present that also has sixteen bits, in which the respective bits are set that are used for group addressing.

A subsequent OR operation of the outputs of the AND operation then tests whether a 1 is output from an AND operation. If this is the case, the OR operation also shows a 1 at the output, and an enabling signal is generated for the bus station. This enabling signal then provides that, for example, a bus station developed as a sensor sends sensor signals over the bus.

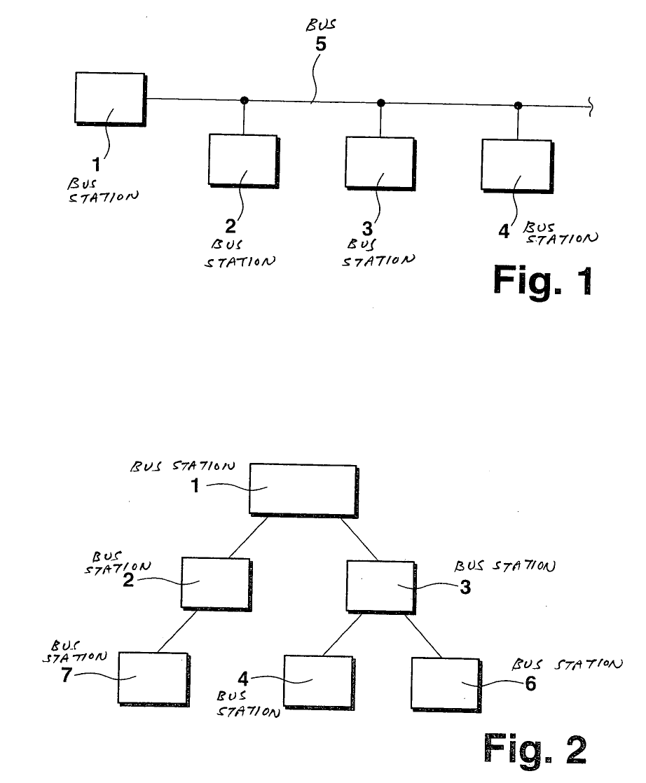

FIG. 1 shows an exemplary parallel bus architecture. Bus stations 1, 2, 3 and 4 are connected a bus 5, such as a CAN bus. Here there are two possibilities of bus organization. In one case, a master-slave architecture may be provided, and then, for instance, bus station 1 is the master and bus stations 2, 3 and 4 the slaves. In a scanning mode, the master may then prompt the individual slaves to send data via bus 5. Another possibility is a multi-master system which, is known, for instance, from the CAN bus. In this case, there will be an arbitration section in which the individual bus stations fight for the right to send data via bus 5. In both bus systems, the master-slave and the multi-master, the use of group addresses is appropriate, since one bus station is able to send data to a plurality of bus stations, or receive data from them.

FIG. 2 shows an exemplary serial bus which is known, for instance, from the fire-wire bus system. Bus station 1 is now connected to bus stations 2 and 3, bus station 7 being connected to bus station 2 and bus stations 4 and 6 respectively being connected to bus station 3. Here too, group addressing is appropriate.

FIG. 4 shows a bus station according to an embodiment of the present invention. The bus station receives a group address via bus 5. A decoder 11 is connected via input lines 17 to the bus via a bus controller (not shown). The bus controller thus permits that the group addresses are transmitted, via the four lines 17 shown, to decoder 11.

Decoder 11 is connected to a logic circuit 12 via an output line 14. Logic circuit 12 has AND circuits which link the individual lines of decoder 11 to the output lines of a mask register 13, pair-wise in each case, that is, bit-wise. The output signals of logic circuit 12, which are the outputs of the individual AND circuits, then lead via lines 16 to an OR circuit 18 which performs an OR linking with one another on the individual output signals. An output signal 19 of OR circuit 18 determines whether an enabling signal can be set or not for the bus station. This enabling signal is generated only if one of lines 16 conducts a logical 1.

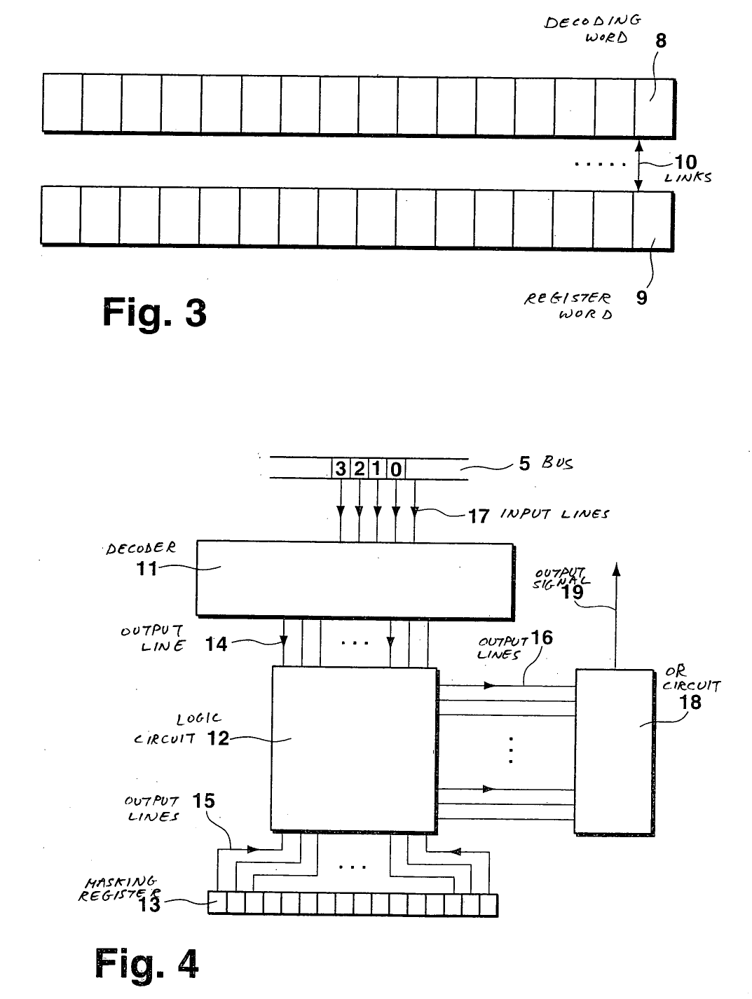

In the example, logic circuit 12 has 16 AND circuits, since the two words, which are here linked to each other, namely, decoding word 8 and register word 9 shown in FIG. 3, are compared, bit-wise in each case, to each other via links 10, and here they are AND circuits. Since the two words each have sixteen bits, there are also sixteen AND circuits present, and thus also sixteen lines which lead to OR circuits. The group addresses which lead to decoder 11 via the lines, are converted by the decoder from, for instance, a hexadecimal representation, into a decimal one. Since the number of decimal numbers able to be coded by the group addresses is known (here there are sixteen), as many bits are provided at the output of the decoder as the number of decimal numbers that are able to be coded by the group addresses. Thus, sixteen outputs are present at the decoder. That means that the decoding word has sixteen bits. Only one of those bits is set, namely the one that indicates the decimal number. Thus, if the number 3 is intended, then the third bit is set, the numbers from 1 through 16 being coded in this case. The register word which contains the individual group addresses that are permissible for the particular bus station is permanently stored in register 13. This also has 16 bits, a plurality of bits being able to be set here which correspond to a plurality of decimal numbers that represent permissible addresses for the bus station. For example, in this case, all even numbers may be coded, so that all even group addresses are recognized as being permissible for the bus station.

Logic circuit 12 of decoder 11, as well as OR circuit 18 and masking register 13 can be produced on one chip as a digital circuit. Besides the components shown here, in the bus station additional components are present, such as the bus controller, sensors and further processing units. An energy supply should also be provided. Which units are additionally present depends particularly on the application to be made of the bus station. If a sensor, for example, is involved in the case of a bus station, then a sensor element, a measuring amplifier and an analog-digital converter must also be present. In the case of a sensor bus in a motor vehicle, this may be, for example, an acceleration sensor, a pressure sensor or a temperature sensor. If means of restraint are involved in the case of a bus station, then a firing circuit control, an energy reserve and a firing pellet may be provided. However, other applications, such as a multimedia bus in the motor vehicle, are also possible in this connection. For example, a navigation unit, a CD player or an automobile radio or a mobile telephone may be connected to the bus as a bus station according to the present invention.

Besides such motor vehicle applications, there are also applications in the home, such as an house wiring bus or a sensor bus in a home, for instance, for monitoring, or even bus stations in an extension system that is in a message-switching processor.

1-7. (canceled).

8. A bus station addressable using at least one group address, comprising:
a decoder configured to convert a group address received via a bus into a decimal group address, the decoder being configured to set a bit for the decimal group address in a decoding word;
a register configured to store at least one permissible group address associated with the bus station as a register word; and
a logic circuit configured to compare the decoding word with the register word and generate an enabling signal for the bus station depending on a result of the comparison.

9. The bus station of claim 8, wherein the logic circuit includes a plurality of AND circuits and an OR circuit, the AND circuits coupling each bit of the decoding word with a corresponding bit of the register word, and wherein outputs of the AND circuits are coupled to inputs of the OR circuit.

10. The bus station of claim 8, wherein the bus station includes a sensor.

11. The bus station of claim 8, wherein the bus station includes a means of restraint.

12. The bus station of claim 8, wherein the bus station is a slave station to another bus station.

13. A bus system, comprising:
a bus; and
a plurality of bus stations, each of the plurality of bus stations including:
a decoder configured to convert a group address received via the bus into a decimal group address, the decoder being configured to set a bit for the decimal group address in a decoding word;
a register configured to store at least one permissible group address associated with the bus station as a register word; and
a logic circuit configured to compare the decoding word with the register word and generate an enabling signal for the bus station depending on a result of the comparison.

14. The bus system of claim 13, wherein the plurality of bus stations include at least one slave station and at least one master station.
